(19) United States
(12) Patent Application Publication
(10) Pub. No.: US 2023/0034553 A1
(43) Pub. Date: Feb. 2, 2023

(54) LIGHT RECEIVING MODULE AND LIDAR APPARATUS COMPRISING THE SAME

(71) Applicant: HL KLEMOVE CORP., Incheon (KR)

(72) Inventors: Yun Ki HAN, Gyeonggi-do (KR); HakGu HAN, Gyeonggi-do (KR); Chulseung LEE, Incheon (KR); Yong Min PARK, Gyeonggi-do (KR); Hyuk RYU, Seoul (KR)

(21) Appl. No.: 17/878,910

(22) Filed: Aug. 2, 2022

(30) Foreign Application Priority Data
Aug. 2, 2021 (KR) 10-2021-0101270

(51) Int. Cl. G01S 7/481; G02B 5/08; G02B 5/28

(52) U.S. Cl. CPC G01S 7/4816; G02B 5/0825; G02B 5/285; G01S 17/10

(57) ABSTRACT

Disclosed are a light receiving module and a light detection and ranging (LIDAR) including the same. The light receiving module according to one embodiment of the present disclosure includes a receiving lens configured to receive external light, a reflective mirror configured to selectively reflect some of the light received by the receiving lens, and a detector configured to detect the light reflected by the reflective mirror, wherein the reflective mirror includes a mirror body having a first surface on a side on which the light received by the receiving lens is incident and a second surface on an opposite side of the first surface, a reflective layer provided on the first surface to reflect light in a designed wavelength region selected according to a predetermined criterion among the light received by the receiving lens, and to transmit light in a noise wavelength region other than the designed wavelength region, and a transmissive layer provided on the second surface so that the light in the noise wavelength region that has passed through the mirror body is transmitted.

### CROSS-REFERENCE TO RELATED APPLICATION

This application claims priority to and the benefit of Korean Patent Application No. 2021-0101270, filed on Aug. 2, 2021, the disclosure of which is incorporated herein by reference in its entirety.

### BACKGROUND

### 1. Field of the Invention

The present disclosure relates to a light receiving module and a light detection and ranging (LIDAR) apparatus including the same, and more particularly, to a light receiving module for receiving light reflected from the outside and traveling, and a LIDAR apparatus including the same.

### 2. Discussion of Related Art

In recent years, light detection and ranging (LIDAR) apparatuses, which are laser radar apparatuses for detecting surrounding terrain or objects, have been widely installed in vehicles or mobile robots. The LIDAR apparatus irradiates a surrounding area with laser light and uses the time and intensity of light reflected from the surrounding object to detect a distance to an object to be measured, a shape and speed of the object to be measured, and the like.

The LIDAR apparatus includes a light receiving module for receiving and detecting reflected light, and a detector of the light receiving module is sensitive to light in a designed wavelength region. In order to increase the detection accuracy of the detector, it is necessary to block light in a noise wavelength region (e.g., a visible light region) other than the designed wavelength region from being introduced into the detector.

Conventionally, in order to block optical noise in the noise wavelength region, a bandpass filter that transmits only light in the designed wavelength region is generally disposed in a receiving optical system. However, since the efficiency of the bandpass filter is not 100%, there is a certain limit to blocking the optical noise, and the structure of the light receiving module is complicated due to the bandpass filter.

Meanwhile, in order to miniaturize the LIDAR apparatus, an optical system for changing an optical axis by disposing a reflective mirror in the light receiving module of the LIDAR apparatus is also applied. In this regard, in the related art, a structure in which a reflective mirror is fixed inside a barrel is generally used. In such a structure, a process of combining the reflective mirror and the barrel is required to be performed in a state in which the reflective mirror is positioned inside the barrel. Accordingly, there is a problem that the manufacturing efficiency of the light receiving module is lowered.

### PRIOR ART DOCUMENT

[Patent Document]
Korean Patent Laid-Open No. 10-2019-0014314 “LIDAR sensor module”, published on Feb. 12, 2019

### SUMMARY OF THE INVENTION

The present disclosure is directed to providing a light receiving module capable of improving blocking efficiency of optical noise without applying a bandpass filter, and a light detection and ranging (LIDAR) apparatus including the same.

Also, the present disclosure is directed to providing to a light receiving module having high manufacturing efficiency through a structure capable of miniaturization through a reflective mirror and fixing the reflective mirror on the outside of a barrel, and a LIDAR apparatus including the same.

According to an aspect of the present disclosure, there is provided a light receiving module including: a receiving lens configured to receive external light; a reflective mirror configured to selectively reflect some of the light received by the receiving lens; and a detector configured to detect the light reflected by the reflective mirror, wherein the reflective mirror includes a mirror body having a first surface on a side on which the light received by the receiving lens is incident and a second surface on an opposite side of the first surface, a reflective layer provided on the first surface to reflect light in a designed wavelength region selected according to a predetermined criterion among the light received by the receiving lens and to transmit light in a noise wavelength region other than the designed wavelength region, and a transmissive layer provided on the second surface so that the light in the noise wavelength region that has passed through the mirror body is transmitted.

In this case, the reflective layer may be formed of a dielectric coating layer. In addition, the designed wavelength region may be selected in a range of 850 to 950 nm.

In addition, the transmissive layer may be formed of an anti-reflection coating layer.

In addition, the transmissive layer may include two or more anti-reflection coating layers that transmit light in different wavelength regions within the noise wavelength region.

In addition, the noise wavelength region may include a range of 300 to 850 nm and a range of 950 to 1100 nm.

In addition, the mirror body may be made of a black glass material that absorbs light in a visible light wavelength region.

In addition, the receiving lens and the detector may be arranged such that an optical axis of the receiving lens and a central axis of the detector meet perpendicularly, and the reflective mirror may be arranged to be inclined at a predetermined angle with respect to the optical axis.

The light receiving module may further include a barrel in which the receiving lens and the reflecting mirror are coupled to each other, and configured to form an optical path between the receiving lens and the reflecting mirror and between the reflecting mirror and the detector.

The light receiving module may further include a barrel configured to allow the receiving lens and the reflective mirror to be coupled to each other and to provide an optical path between the receiving lens and the reflective mirror and between the reflecting mirror and the detector.

In addition, the reflective mirror may be coupled to the barrel in such a manner that the second surface is arranged outside the barrel.

In addition, a reflective mirror coupling unit of the barrel to which the reflective mirror is coupled may be formed to allow the reflective mirror to be seated and fixed on the outside of the barrel.

In addition, the reflective mirror coupling unit may be formed to allow at least a portion of an edge of the reflective mirror to be seated while the at least a portion of the first surface of the reflective mirror is exposed into the barrel.

According to another aspect of the present disclosure, there is provided a LIDAR apparatus including a light transmitting module configured to transmit laser light to the outside; and the light receiving module configured to receive external light including laser light reflected and returned from the outside.

In this case, the laser light may include light in the designed wavelength region.

According to one embodiment of the present disclosure, it is possible to improve the blocking efficiency of the optical noise of a light receiving module and a LIDAR apparatus including the same through a reflective layer provided on a reflective mirror and a transmissive layer provided on the reflective mirror to transmit light in a noise wavelength region other than a designed wavelength region even without applying a bandpass filter, so that the detector can reflect light in the designed wavelength range with a high sensitivity.

In addition, according to one embodiment of the present disclosure, it is possible to improve the manufacturing efficiency of a light receiving module and a LIDAR apparatus including the same through a structure which can seat and fix a reflective mirror on the outside of a barrel.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a configuration diagram of a light receiving module according to one embodiment of the present disclosure;

FIG. 2 is a graph illustrating a designed wavelength region used in the light receiving module according to one embodiment of the present disclosure;

FIG. 3 is a diagram illustrating a propagation path of light in the designed wavelength region in the light receiving module according to one embodiment of the present disclosure;

FIG. 4 is a diagram illustrating a propagation path of light in a noise wavelength region in the light receiving module according to one embodiment of the present disclosure;

FIG. 5 is a diagram illustrating the arrangement of a receiving lens, a reflective mirror, and a detector in the light receiving module according to one embodiment of the present disclosure;

FIG. 6 is a diagram illustrating an assembly process of a reflective mirror in the light receiving module according to one embodiment of the present disclosure;

FIG. 7 is a diagram illustrating a portion A of FIG. 6;

FIG. 8 is a diagram illustrating a modified example of a reflective mirror coupling unit of FIG. 7;

FIG. 9 is a diagram illustrating a configuration and operation of a LIDAR apparatus according to one embodiment of the present disclosure; and

FIG. 10 is a graph illustrating the concept of light transmission and reception of the LIDAR apparatus according to one embodiment of the present disclosure.

### DETAILED DESCRIPTION OF EXEMPLARY EMBODIMENTS

Hereinafter, embodiments of the present disclosure will be described in detail so that those of ordinary skill in the art to which the present disclosure pertains can easily implement them. However, the present disclosure may be embodied in various different forms and is not limited to the embodiments described herein. In addition, parts irrelevant to the description will be omitted to clearly describe the embodiments of the present disclosure, and like reference numerals are given to like components throughout the specification.

In the specification, it should be understood that the terms such as “comprise” or “have” are intended to indicate the presence of features, numbers, steps, acts, components, parts or combinations thereof disclosed in the specification and are not intended to exclude the possibility of the presence or addition of one or a plurality of other features, numbers, steps, acts, components, parts or combinations thereof.

In this specification, spatially relative terms “front”, “rear”, “upper” or “lower” may be used to describe a correlation with the components shown in the drawings. These are relative terms determined based on what is shown in the drawings, and the positional relationship may be conversely interpreted according to the orientation.

The presence of an element “in front”, “behind”, “above” or “below” of another element means that, unless otherwise specified, it is directly in contact with another element, such as “front”, “rear”, “above” or “below”. It includes not only being disposed in the “lower part” but also cases in which another component is disposed in the middle. In addition, that a component is “connected” with another component includes not only direct connection to each other, but also indirect connection to each other, unless otherwise specified.

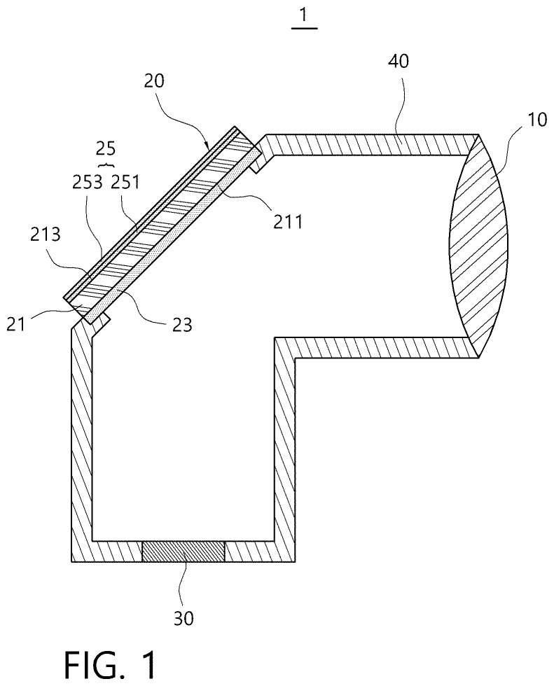

FIG. 1 is a configuration diagram of a light receiving module according to one embodiment of the present disclosure.

A light receiving module 1 according to one embodiment of the present disclosure receives and detects light introduced from the outside. The light receiving module 1 may be used in a light detection and ranging (LIDAR) apparatus. That is, the light receiving module 1 according to one embodiment of the present disclosure may be arranged inside the LIDAR apparatus to detect reflected light such that laser light irradiated to a surrounding area is reflected and returned by a surrounding object.

Referring to FIG. 1, the light receiving module 1 according to one embodiment of the present disclosure may include a receiving lens 10, a reflective mirror 20, a detector 30, and a barrel 40.

The receiving lens 10 receives external light. The receiving lens 10 forms an optical path so that light introduced from the outside propagates toward the reflective mirror 20. In other words, in the light receiving module 1 according to one embodiment of the present disclosure, the receiving lens 10 serves as a receiving optical system. In one embodiment of the present disclosure, additional optical devices may be arranged in addition to the receiving lens 10 in some cases for efficient light collection to the reflective mirror 20.

The reflective mirror 20 selectively reflects some of the light received by the receiving lens 10. In more detail, the reflective mirror 20 reflects light in a wavelength region selected according to a predetermined criterion from the light collected by the receiving lens 10, toward the detector 30.

Hereinafter, the wavelength region selected according to the predetermined criterion is referred to as a designed wavelength region. In this case, the predetermined criterion may be determined in consideration of the sensitivity of the detector 30, and may vary depending on the characteristics of the detector 30. Meanwhile, a wavelength region other than the designed wavelength region is referred to as a noise wavelength region.

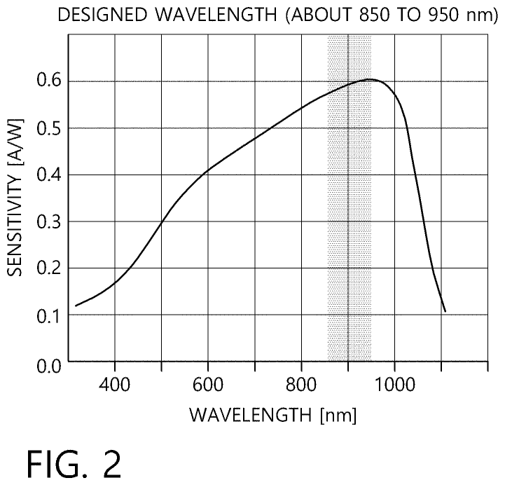

Referring to FIG. 2, in one embodiment of the present disclosure, the designed wavelength range may be 850 to 950 nm. In addition, the designed wavelength range may be selected to be some range from 850 to 950 nm. For example, the designed wavelength range may be 870 nm to 930 nm.

The remaining wavelength region other than the designed wavelength region may be classified as a noise wavelength region. When the designed wavelength region is 850 to 950 nm, the noise wavelength region may be in the range of 300 to 850 nm and 950 to 1100 nm.

In the light receiving module 1 according to one embodiment of the present disclosure, the reflective mirror 20 makes it possible to increase the blocking efficiency of optical noise without applying a bandpass filter. The external light introduced through the receiving lens 10 includes light in the designed wavelength region and light in the noise wavelength region. The reflective mirror 20 is configured to selectively reflect light in the designed wavelength region selected in consideration of the sensitivity of the detector 30 among the light received by the receiving lens 10.

In one embodiment of the present disclosure, the reflective mirror 20 includes a mirror body 21, a reflective layer 23, and a transmissive layer 25.

The mirror body 21 has a first surface 211 on a side on which the light received by the receiving lens 10 is incident, and a second surface 213 on an opposite side of the first surface 211. In one embodiment of the present disclosure, the first surface 211 of the mirror body 21 may be arranged inside the barrel 40, and the second surface 213 may be arranged outside the barrel 40.

The mirror body 21 may be made of a black glass material. As described above, in one embodiment of the present disclosure, the designed wavelength region may be selected in the range of 850 to 950 nm. Accordingly, since a visible light region (a wavelength range of 400 to 700 nm) belongs to the noise wavelength region, the light may be transmitted through the mirror body 21 or absorbed by the mirror body 21. Since the black glass material has a property of absorbing light in the visible light wavelength region, when the mirror body 21 is made of the black glass material, it is possible to effectively block light in the visible light wavelength region belonging to the noise wavelength region from being reflected in the mirror body 21 and propagating to the detector 30.

The reflective layer 23 is provided on the first surface 211 to reflect the light in the designed wavelength region among the light received by the receiving lens 10 and to pass the light in the noise wavelength region other than the designed wavelength region. As described above, the designed wavelength region may be selected in the range of 850 nm to 950 nm, and accordingly, the reflective layer 23 may be formed to reflect light in the designed wavelength region selected in the range of 850 nm to 950 nm.

In one embodiment of the present disclosure, the reflective layer 23 may be formed of a dielectric coating layer. More specifically, the reflective layer 23 may be formed of a dielectric high-reflection coating layer.

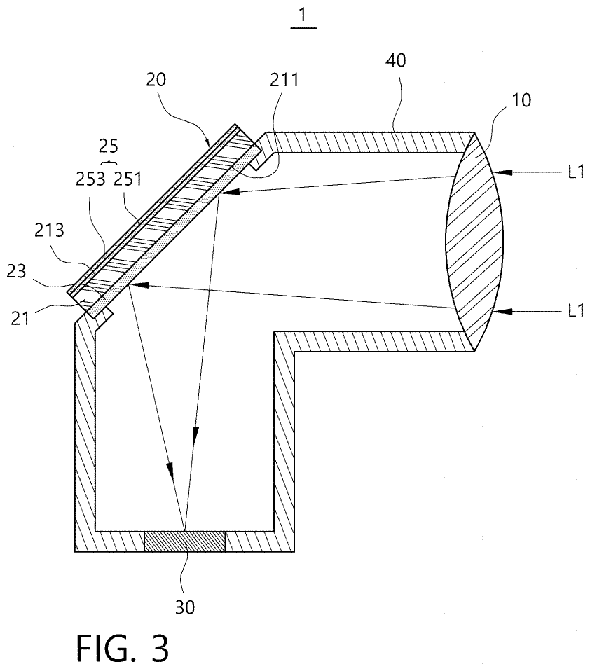

FIG. 3 is a diagram illustrating a propagation path of light in the designed wavelength region in the light receiving module according to one embodiment of the present disclosure.

Referring to FIG. 3, light L 1 of the designed wavelength region among the external light received by the receiving lens 10 is condensed toward the reflective mirror 20 by the receiving lens 10, and is reflected by the reflective layer 23 provided on the first surface 211 of the reflective mirror 20 to propagate to the detector 30. That is, the reflective layer 23 prevents the light L1 of the designed wavelength region from propagating into the mirror body 21 and reflects the light L1 of the designed wavelength region toward the detector 30.

The transmissive layer 25 is provided on the second surface 213 so that the light in the noise wavelength region that has passed through the mirror body 21 is transmitted and propagates to the outside of the reflective mirror 20. When the designed wavelength range is 850 to 950 nm, the noise wavelength range may include a range of 300 to 850 nm and a range of 950 to 1100 nm.

The transmissive layer 25 may be formed of an anti-reflection coating layer. In addition, the transmissive layer 25 may include two or more anti-reflection coating layers that transmit light in different wavelength regions within the noise wavelength region.

In one embodiment of the present disclosure, the transmissive layer 25 includes a first anti-reflection coating layer 251 provided on the second surface 213 of the mirror body 21 and a second anti-reflection coating layer 253 provided on the first anti-reflection coating layer 251. For example, the first anti-reflection coating layer 251 transmits, without reflection, light in any one of the range of 300 to 850 nm and the range of 950 to 1100 nm, and the second anti-reflection coating layer 253 transmits, without reflection, light in the remaining other range.

Obviously, the transmissive layer 25 may include three or more anti-reflection coating layers. Accordingly, the wavelength region of the light that each anti-reflection coating layer transmits without reflection may be further categorized.

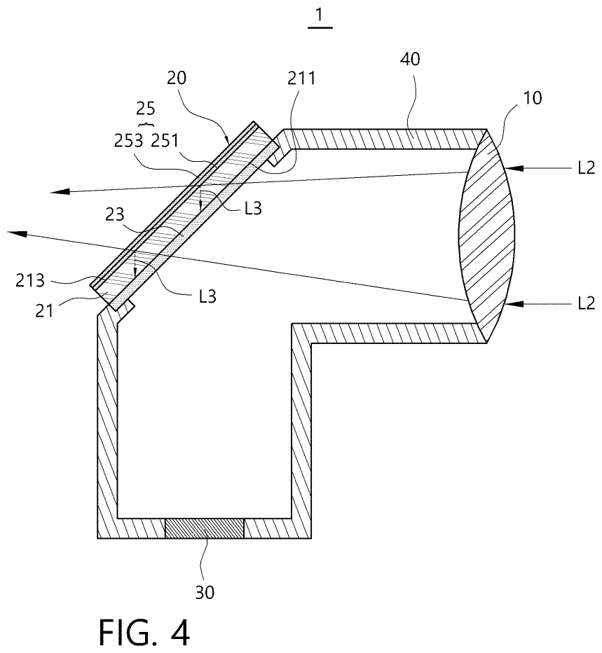

FIG. 4 is a diagram illustrating a propagation path of light in the noise wavelength region in the light receiving module according to one embodiment of the present disclosure.

Referring to FIG. 4, light L2 in the noise wavelength region among the external light received by the receiving lens 10 is condensed toward the reflective mirror 20 by the receiving lens 10, and is transmitted through the reflective layer 23 provided on the first surface 211 of the reflective mirror 20 to pass through the mirror body 21. Most of the light L2 in the noise wavelength region that has passed through the mirror body 21 and has reached the second surface 213 is transmitted through the transmissive layer 25 and propagates to the outside of the light receiving module 1.

In addition, some of the light L2 in the noise wavelength region having passed through the mirror body 21 and having reached the second surface 213 is reflected from the second surface 213 to the inside of the mirror body 21 so that the light L2 may become noise reflected light L3. In this case, when the mirror body 21 is made of black glass, light in the visible light region among the noise reflected light L3 is absorbed by the mirror body 21 and does not propagate toward the detector 30.

Meanwhile, in one embodiment of the present disclosure, the reflective mirror 20 is coupled to the barrel 40 in such a manner that the second surface 213 is arranged outside the barrel 40. Accordingly, the light transmitted through the transmissive layer 25 via the second surface 213 propagates to the outside of the light receiving module 1. Therefore, the light transmitted through the transmissive layer 25 is fundamentally prevented from being reflected by other components of the light receiving module 1 and propagating toward the detector 30.

The detector 30 detects the light reflected by the reflective mirror 20. The light detected by the detector 30 may be converted into distance information to an external object through signal processing.

In order to perform accurate detection by the detector 30, it is necessary to minimize the introduction of light in the noise wavelength region, not the light in the designed wavelength region, to the detector 30. As described above, according to one embodiment of the present disclosure, the reflective mirror 20 reflects the light in the designed wavelength region toward the detector 30 and transmits the light in the noise wavelength region through the reflective mirror 20, so that the detector 30 can effectively detect the light in the designed wavelength region.

The detector 30 may be made of a silicon (Si) material. In addition, the detector 30 may include a mount for fixing, a circuit board for signal processing and the like, in addition to an optical detection element.

The barrel 40 is provided such that the receiving lens 10 and the reflective mirror 20 are coupled to each other, and forms an optical path between the receiving lens 10 and the reflective mirror 20 and between the reflective mirror 20 and the detector 30. In the barrel 40, the reflective mirror 20 may be arranged to be inclined at a predetermined angle with respect to the optical axis of the receiving lens 10.

The light receiving module 1 according to one embodiment of the present disclosure provides high manufacturing efficiency through a structure in which the light receiving module 1 can be miniaturized through the reflective mirror 20 and the reflective mirror 20 can be fixed on the outside of the barrel 40.

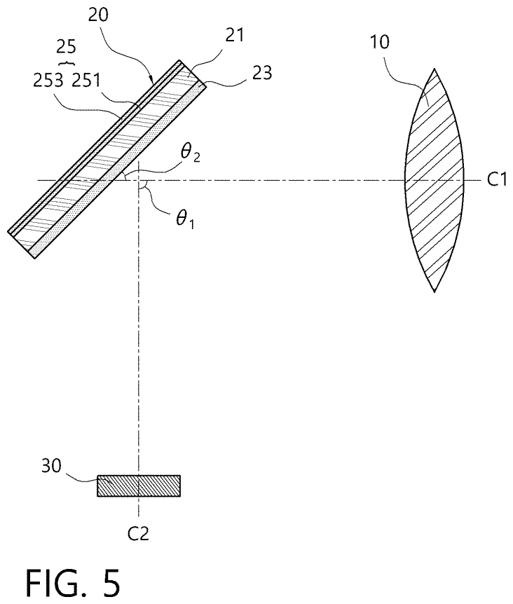

FIG. 5 is a diagram illustrating the arrangement of the receiving lens, the reflective mirror, and the detector in the light receiving module according to one embodiment of the present disclosure.

Referring to FIG. 5, the receiving lens 10 and the detector 30 are arranged in such a manner that an optical axis C1 of the receiving lens 10 and a central axis C2 of the detector 30 form a first angle θ1. In this case, the first angle θ1 may be 90 degrees. That is, the receiving lens 10 and the detector 30 may be arranged such that the optical axis C1 of the receiving lens 10 and the central axis C2 of the detector 30 meet vertically. In addition, the reflective mirror 20 is arranged to be inclined at a second angle θ2 with respect to the optical axis C1.

As shown in FIG. 5, by changing the optical axis through the reflective mirror 20, the space efficiency of the light receiving module 1 can be increased, the size can be reduced, and the detector 30 can be efficiently arranged.

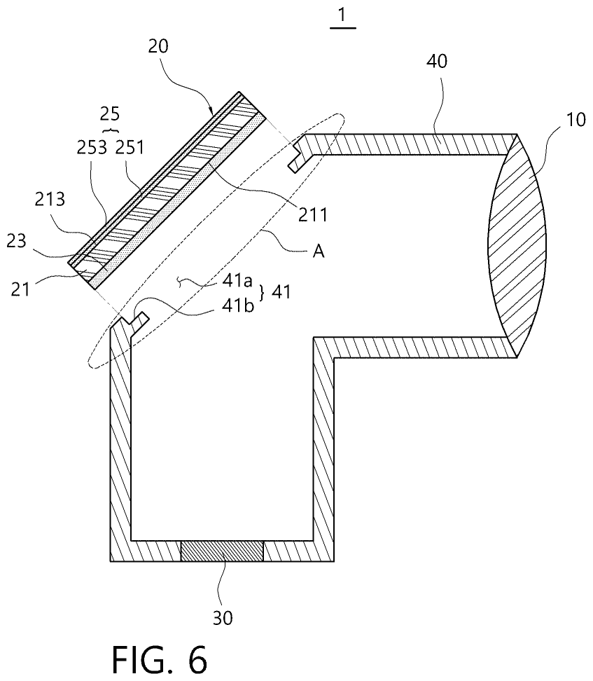

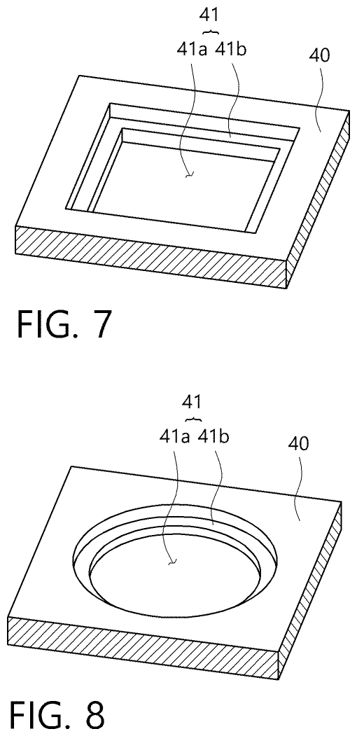

Meanwhile, FIG. 6 is a diagram illustrating an assembly process of the reflective mirror in the light receiving module according to one embodiment of the present disclosure. In addition, FIG. 7 is a diagram illustrating a portion A of FIG. 6.

Referring to FIGS. 6 and 7, in one embodiment of the present disclosure, a reflective mirror coupling unit 41 of the barrel 40 to which the reflective mirror 20 is coupled may be provided to allow the reflective mirror 20 to be seated and fixed on the outside of the barrel 40.

When the reflective mirror coupling unit to which the reflective mirror 20 is coupled is present inside the barrel 40, a coupling process is performed while the reflective mirror 20 is positioned inside the barrel 40 so that the manufacturing efficiency is inevitably reduced. However, according to one embodiment of the present disclosure, the reflective mirror coupling unit 41 is provided to allow the reflective mirror 20 to be seated and fixed on the outside of the barrel 40, so that the reflective mirror 20 can be easily coupled to the barrel 40.

For example, the reflective mirror coupling unit 41 may be provided to allow at least a portion of an edge of the reflective mirror 20 to be seated while at least a portion of the first surface 211 of the reflective mirror 20 is exposed into the barrel 40. Specifically, the reflective mirror coupling unit 41 may include a through-hole 41a provided to expose the first surface 211 of the reflective mirror 20 into the barrel 40, and a seating protrusion 41b provided around the through-hole 41a. In this case, the through-hole 41a may be provided to be smaller than the reflective mirror 20, and the seating protrusion 41b may be provided such that the edge of the reflective mirror 20 entering from the outside of the barrel 40 is caught by the seating protrusion 41b.

FIG. 8 is a diagram illustrating a modified example of the reflective mirror coupling unit of FIG. 7. Referring to FIG. 8, the reflective mirror 20 may be formed in a circular shape. In this case, the shapes of the through-hole 41a and the seating protrusion 41b of the reflective mirror coupling unit 41 may be changed to a circular shape to conform to the changed shape of the reflective mirror 20.

In the above, the light receiving module 1 according to one embodiment of the present disclosure has been described. The light receiving module 1 according to one embodiment of the present disclosure may be applied to a light detection and ranging (LIDAR) apparatus. Hereinafter, a LIDAR apparatus including the light receiving module 1 according to one embodiment of the present disclosure will be described.

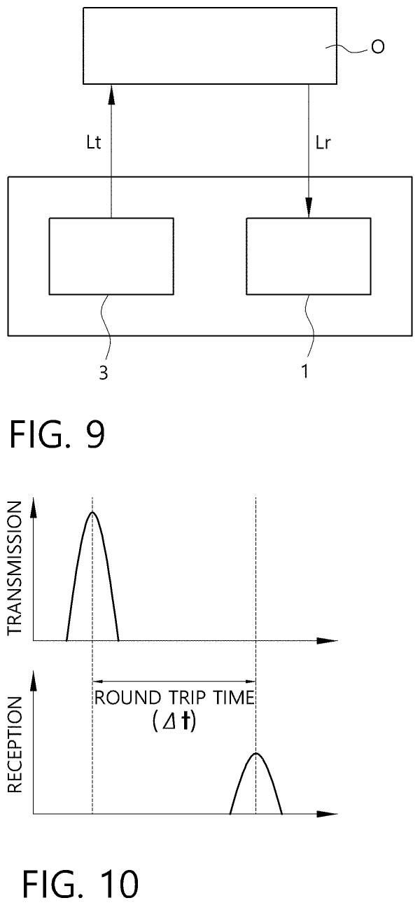

FIG. 9 is a diagram illustrating a configuration and operation of the LIDAR apparatus according to one embodiment of the present disclosure.

The LIDAR apparatus according to one embodiment of the present disclosure may be an apparatus that transmits laser light and receives the laser light reflected back by an external object O to detect a distance to the external object, a shape of the external object, and the like. The LIDAR apparatus according to one embodiment of the present disclosure may be installed in a vehicle and used as a means for collecting information necessary for driver assistance or autonomous driving of the vehicle.

Referring to FIG. 9, the LIDAR apparatus according to one embodiment of the present disclosure includes a light transmitting module 3 and the light receiving module 1.

The light transmitting module 3 transmits laser light to the outside. In this case, the laser light may include light in the designed wavelength region. As described above, the designed wavelength region may be selected from the range of 850 to 950 nm. The light transmitting module 3 may include a laser light source that generates pulsed laser light, a transmitting optical system that aligns a transmission path of the laser light, and the like.

The light receiving module 1 receives external light including the laser light reflected from the outside and returned. The light receiving module 1 detects the laser light transmitted by the light transmitting module 3 and reflected and returned by the external object O to measure a distance to the external object O, and the like.

Detailed components of the light receiving module 1 are the same as described above, and thus a detailed description thereof will be omitted.

FIG. 10 is a graph illustrating the concept of light transmission and reception of the LIDAR apparatus according to one embodiment of the present disclosure.

Referring to FIG. 10, a time when the laser light in the designed wavelength region transmitted from the light transmitting module 3 is reflected by the external object O and returned to the light receiving module 1, that is, a round trip time Δt of the laser light corresponds to a distance from the LIDAR apparatus to the external object O. Accordingly, the distance to the external object O can be measured based on the round trip time Δt of the laser light.

Although one embodiment of the present disclosure has been described, the spirit of the present disclosure is not limited to the embodiment disclosed herein, and it should be understood that those skilled in the art can devise numerous other embodiments falling within the same spirit and scope of this disclosure through addition, modification, removal, supplementation, and the like of a component, and these other embodiments will also fall within the spirit and scope of the present disclosure.

1. A light receiving module comprising:
a receiving lens configured to receive external light;
a reflective mirror configured to selectively reflect some of the light received by the receiving lens; and
a detector configured to detect the light reflected by the reflective mirror,
wherein the reflective mirror includes:
a mirror body having a first surface on a side on which the light received by the receiving lens is incident and a second surface on an opposite side of the first surface;
a reflective layer provided on the first surface to reflect light in a designed wavelength region selected according to a predetermined criterion among the light received by the receiving lens, and to transmit light in a noise wavelength region other than the designed wavelength region; and
a transmissive layer provided on the second surface so that the light in the noise wavelength region that has passed through the mirror body is transmitted.

2. The light receiving module of claim 1, wherein the reflective layer is formed of a dielectric coating layer.

3. The light receiving module of claim 1, wherein the designed wavelength region is selected in a range of 850 to 950 nm.

4. The light receiving module of claim 1, wherein the transmissive layer is formed of an anti-reflection coating layer.

5. The light receiving module of claim 4, wherein the transmissive layer includes two or more anti-reflection coating layers that transmit light in different wavelength regions within the noise wavelength region.

6. The light receiving module of claim 5, wherein the noise wavelength region includes a range of 300 to 850 nm and a range of 950 to 1100 nm.

7. The light receiving module of claim 1, wherein the mirror body is made of a black glass material that absorbs light in a visible light wavelength region.

8. The light receiving module of claim 1, wherein the receiving lens and the detector are arranged such that an optical axis of the receiving lens and a central axis of the detector meet perpendicularly, and
the reflective mirror is arranged to be inclined at a predetermined angle with respect to the optical axis.

9. The light receiving module of claim 1, further comprising a barrel in which the receiving lens and the reflecting mirror are coupled to each other, and configured to form an optical path between the receiving lens and the reflecting mirror and between the reflecting mirror and the detector.

10. The light receiving module of claim 9, wherein the reflective mirror is coupled to the barrel in such a manner that the second surface is arranged outside the barrel.

11. The light receiving module of claim 9, wherein a reflective mirror coupling unit of the barrel to which the reflective mirror is coupled is formed to allow the reflective mirror to be seated and fixed on the outside of the barrel.

12. The light receiving module of claim 11, wherein the reflective mirror coupling unit is formed to allow at least a portion of an edge of the reflective mirror to be seated while the at least a portion of the first surface of the reflective mirror is exposed into the barrel.

13. A light detection and ranging (LIDAR) apparatus comprising:
a light transmitting module configured to transmit laser light to an outside; and
the light receiving module of claim 1 configured to receive external light including the laser light reflected and returned from the outside.

14. The LIDAR apparatus of claim 13, wherein the laser light includes light in the designed wavelength region.
